(19) United States
(12) Patent Application Publication
(10) Pub. No.: US 2025/0141794 A1
(43) Pub. Date: May 1, 2025

(54) PROGRAMMING A PACKET PROCESSING DEVICE

(71) Applicant: Intel Corporation, Santa Clara, CA (US)

(72) Inventors: Xiao WANG, Shanghai (CN); Sridhar SAMUDRALA, Portland, OR (US); Zhirun YAN, Shanghai (CN); Ji LI, Shanghai (CN); Mohammad Abdul AWAL, Celbridge (IE); Qi ZHANG, Shanghai (CN); Ping YU, Shanghai (CN); Yadong LI, Portland, OR (US); Hieu TRAN, Portland, OR (US); Jayaprakash SHANMUGAM, Portland, OR (US)

(21) Appl. No.: 18/518,814

(22) Filed: Nov. 24, 2023

(30) Foreign Application Priority Data
Oct. 27, 2023 (WO) PCT/CN2023/127363

(51) Int. Cl. H04L 45/00; H04L 45/42; H04L 45/741

(52) U.S. Cl. CPC H04L 45/566; H04L 45/42; H04L 45/741

(57) ABSTRACT

Examples described herein relate to a network interface device. In some examples, the network interface device includes a host interface; a direct memory access (DMA) circuitry; a network interface; and circuitry. The circuitry can be configured to: apply, for a tunnel packet, a single match-action rule that comprises a value of the encapsulation header of the tunnel packet and a value of the encapsulated header, wherein the single match-action rule is based on two or more match-action rules.

### RELATED APPLICATION

This application claims the benefit of priority to Patent Cooperation Treaty (PCT) Application No. PCT/CN2023/127363, filed Oct. 27, 2023. The entire contents of that application are incorporated by reference.

### BACKGROUND

Tunneling protocols can be used for transporting packets across a network using protocols that are not supported by the network. Transmitted packets can be tunneled using a variety of different tunnel protocols that define encapsulation and decapsulation protocols. Examples of tunnel protocols include Multiprotocol Label Switching (MPLS), Label Distribution Protocol (LDP), Segment Routing over IPv6 dataplane (SRv6), Virtual Extensible LAN (VXLAN) tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth. VXLAN can be based on Network Working Group Request for Comments (RFC) 4789 (2006).

### BRIEF DESCRIPTION OF THE DRAWINGS

FIG. 1 shows a known two-stage design of tunnel hardware offload operation in the packet receipt (Rx) direction.

FIG. 2 shows examples of offloading packet processing to a packet processing pipeline of a network interface device.

FIG. 3 shows an example of a packet processing pipeline performing multiple stage match-action lookup.

FIG. 4 depicts an example system.

FIG. 5A depicts a process of merging rules.

FIG. 5B depicts a process of applying merged rules.

FIG. 6 depicts an example of a VXLAN frame.

FIG. 7A depicts an example of multiple flow rules.

FIG. 7B depicts an example of a flattened flow rule from multiple flow rules.

FIG. 8 depicts an example flow of tunnel offload API mediation.

FIG. 9A depicts an example process.

FIG. 9B depicts an example process. The process can be performed by a network interface device.

FIGS. 10A-10C depict example network interface devices.

FIG. 11 depicts an example system.

### DETAILED DESCRIPTION

Data Plane Development Kit (DPDK) rte_flow based non-tunnel hardware offload design provides for offload of operations to a hardware device (e.g., match+action or match+mark). If an action is not supported by the hardware device, then a partial offload with a flow mark can be performed by the hardware device. The Open vSwitch (OVS) community has defined a generic tunnel offload framework. For example, OVS defined DPDK application programming interfaces (APIs) as rte_flow extensions for packet tunneling. With these rte_flow extension APIs, the tunnel offload framework splits the packet receipt (Rx) (decapsulation direction) processing into two stages.

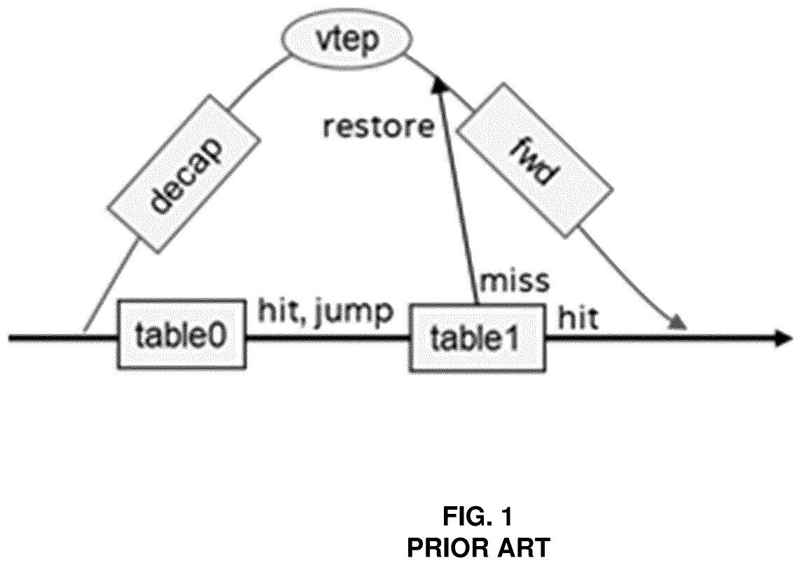

FIG. 1 shows a known two-stage design of OVS tunnel hardware offload operation in the packet receipt (Rx) direction. OVS could use DPDK flow API to offload two rules to be performed by tunnel end point (TEP) ingress processing. Handling of flows in stage 1 and stage 2 can be offloaded into two tables (table0 and table1), respectively. A first rule (e.g., table0) can be performed for matching on a tunnel outer header (e.g., encapsulation header) with a decapsulation action and a second rule (e.g., table1) can be performed for matching on an inner header (e.g., encapsulated header) and tunnel metadata with another action. A packet from an underlay network could be sent to the TEP and the TEP performs decapsulation when the packet matches a match-action rule. In stage 1, if a packet is identified as a tunneled or tunnel packet and it is targeted to a circuitry (e.g., tunnel end point (TEP)), the packet is sent to the TEP for outer header decapsulation. The TEP can be accessible as a logic port and the TEP can perform tunnel header encapsulation and decapsulation functionality. In some examples, rte_flow_tunnel_match( ) API can be used for vendor specific tagging of TEP port inside the hardware offload circuitry.

After tunnel header decapsulation, the forwarding plane could search its rule tables (e.g., table1) for a header value of the decapsulated packet, and if a second match-action rule is found for this new decapsulated packet, an action could be taken on the packet (e.g., forwarding to a port belonging to the virtualized local area network (LAN) network for processing by a target virtual machine (VM), microservice, application, processor, etc.). In stage 2, after the packet outer header is removed, the packet is provided as a decapsulated packet from a TEP port, and the pipeline parses the inner packet header and looks up flow tables with a key to find the forwarding action for the packet.

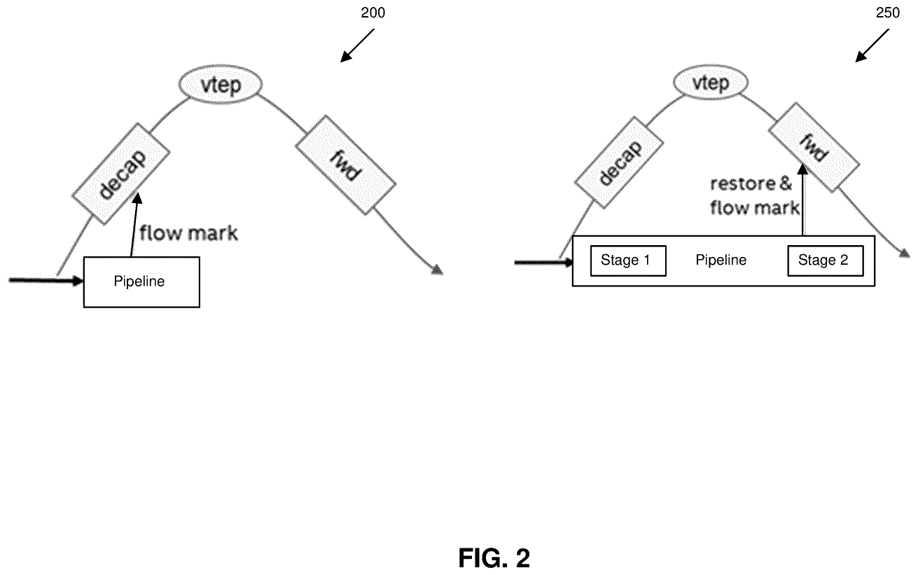

FIG. 2 shows examples of offloading processing of tunneled or tunnel packets to a packet processing pipeline of a network interface device. In system 200, tunnel decapsulation is not supported in the network interface device and the pipeline can perform offloaded flow marking actions. Flow marking could identify a packet's flow and processor-executed software can perform packet parsing and perform flow table lookup to determine an action from a table to perform on the packet based on a header value of the packets.

A hardware packet processing pipeline and/or parser may include capabilities to perform header modification or tunnel header decapsulation. For example, system 250 shows an example of performance of multiple lookup operations by a packet processing pipeline in stages 1 and 2 based on outer and inner header values (keys) for offloading processing of tunneled or tunnel packets to a packet processing pipeline.

Some examples described herein provide circuitry, software, and/or firmware to translate multi-stage flow rules into a flattened flow rule so that a single lookup operation can be performed in a data plane pipeline with a parser on at least tunneled or tunnel packets. The mediation can manage phased offloading rules and merge relevant keys and actions and support flow create/destroy/query APIs by mediating flow configurations and statistics between the two-phased tunnel flows and the flattened flow rule. Hardware offload can be used for processing tunneled packets using offload APIs based on DPDK, or other frameworks. Some examples may not utilize packet recirculation for decapsulating tunneled packets and determining forwarding rules for the tunneled packets. Packet recirculation to a packet processing pipeline for tunnel decapsulation can reduce throughput of packets from the network interface device.

In some examples, a device driver that provides an operating system or process (e.g., application, virtual machine, microservice, or others) with access to the network interface device's packet processing pipeline can perform mediation to translate the two-phased tunnel offload semantics into a flattened single flow rule. Mediation can capture hardware offload API calls from one or more processes and based on the API call information, merge keys of multiple stages (e.g., stage 1 and stage 2) into a single flow rule. Some examples can cause a packet processing pipeline to perform match and mark with packet parsing without packet recirculation based on a flow offload framework (e.g., OVS), using API mediation to convert multiple-phase match-action flows into a flattened one-phase match-action flow to be processed by the packet processing pipeline. Some examples expand match+mark ability into a two-phased TEP offload whereby outer header match causes a send of a packet to a virtual TEP (vTEP) and decapsulation causes the packet associated with the vTEP to be forwarded based on a rule associated with an inner header match.

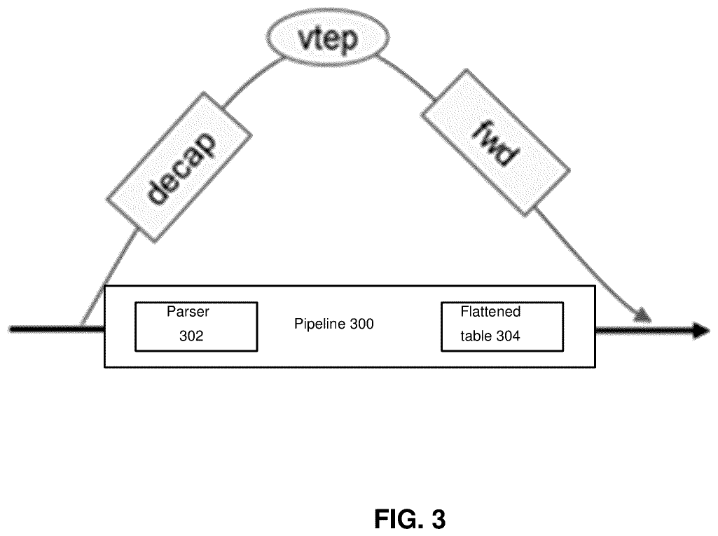

FIG. 3 shows an example of a packet processing pipeline performing single stage match-action lookup. For example, packet parser 302 could perform header parsing and extract protocol fields from a tunnel outer header (e.g., encapsulation header) and inner header (e.g., encapsulated header) and utilize at least one value of these protocol fields as a key to retrieve an entry from lookup table 304. Pipeline 300 can apply rules from flattened table 304 that includes a combined key and a combined actions array, as described herein. If a packet matches to a rule in table 304, pipeline 300 can perform decapsulation and forwarding actions based on a single lookup operation, without recirculation or table-jumping overhead.

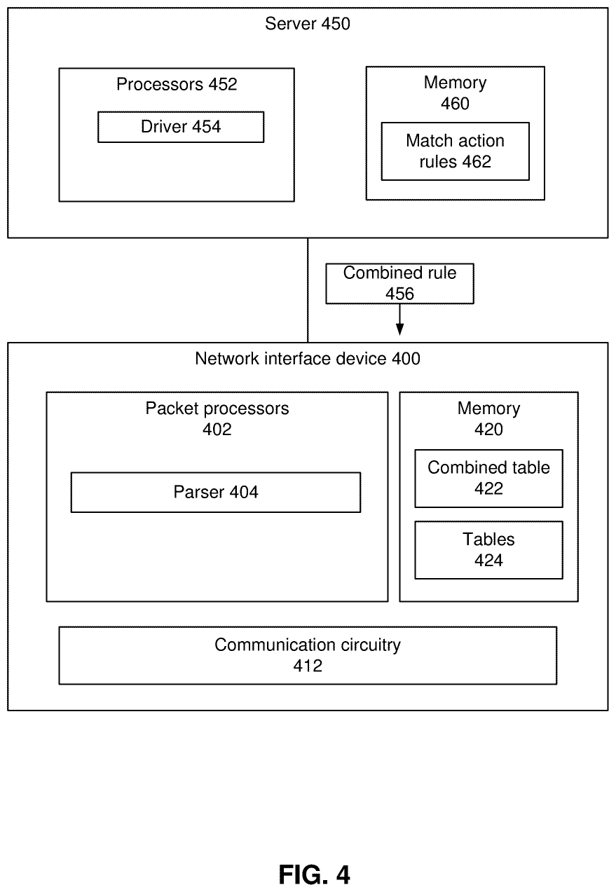

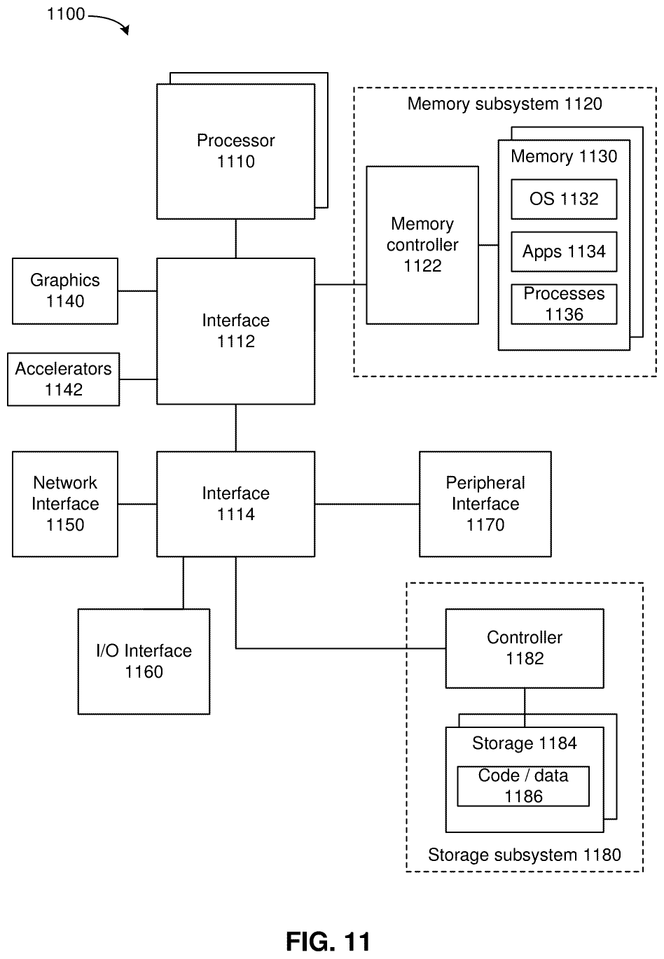

FIG. 4 depicts an example system. Server 450 can be coupled to network interface device 400 using a device interface (e.g., Peripheral Component Interconnect express (PCIe), Compute Express Link (CXL), or others) or network connection, examples of which are described herein. Server 450 can include processors 452, memory 460, and other technologies described herein at least with respect to the system of FIG. 11. Processors 452 can execute device driver 454 for network interface device 400 that can combine multiple rules into a single rule. Driver 454 can process match action rules applied to an outer header and inner header of a tunnel packet and generate a single entry or rule 456 for execution by packet processors 402 of network interface device 400. Driver 454 can mediate the offload APIs of flow create/query/destroy for the underlying packet processing pipeline in an application agnostic manner.

In some examples, network interface device 400 can include one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). A network interface device can include: one or more processors; one or more programmable packet processing pipelines; one or more accelerators; one or more application specific integrated circuits (ASICs); one or more field programmable gate arrays (FPGAs); one or more memory devices; one or more storage devices; or others.

Packet processors 402 can be configured to perform match-action on received packets to identify packet processing rules and next hops using information stored in a ternary content-addressable memory (TCAM) tables or exact match tables in some examples. For example, based on combined rules 456 in combined table 422, packet processors 402 can perform header decapsulation or parsing and determine a next hop for a tunnel packet. For example, a next hop can include another network interface device or a process (e.g., VM, service, microservice, application, or others) executed by server 450 or other circuitry. For example, match-action tables or circuitry can be used whereby a hash of a portion of a packet (e.g., header or payload) is used as an index to find an entry. Packet processors 402 can implement access control list (ACL) to perform packet drops due to queue overflow. Configuration of operation of packet processors 402, including its data plane, can be programmed using configuration file, OneAPI, Programming protocol independent packet processors (P4), Software for Open Networking in the Cloud (SONIC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries.

Parser 404 can perform packet processing to separates packet headers from a payload of the packet as well as outer and inner headers of tunnel packets. Memory 420 can store combined table 422 that includes rules that combine math-actions for tunneled packets. Memory 420 can store tables 424 that include rules that may not be combined, such as match+action or match+mark, and are to be performed by packet processors 402.

A packet may be used herein to refer to various formatted collections of bits that may be sent across a network, such as Ethernet frames, IP packets, TCP segments, UDP datagrams, etc. Also, as used in this document, references to L2, L3, L4, and L7 layers (layer 2, layer 3, layer 4, and layer 7) are references respectively to the second data link layer, the third network layer, the fourth transport layer, and the seventh application layer.

A flow can be a sequence of packets being transferred between two endpoints, generally representing a single session using a known protocol. Accordingly, a flow can be identified by a set of defined tuples or header field values and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

Communication circuitry 412 can provide communications with other devices over a network or fabric via one or more ports. Communication circuitry 412 may be configured to use any one or more communication technology (e.g., wired or wireless communications) and associated protocols (e.g., Ethernet, InfiniBand®, Bluetooth®, Wi-Fi®, 4G LTE, 5G, etc.) to perform such communication. Communication circuitry 412 can include one or more network hardware resources, such as ingress queues, egress queues, crossbars, shared memory switches, media access control (MAC), physical layer interface (PHY), Ethernet port logic, and other network hardware resources.

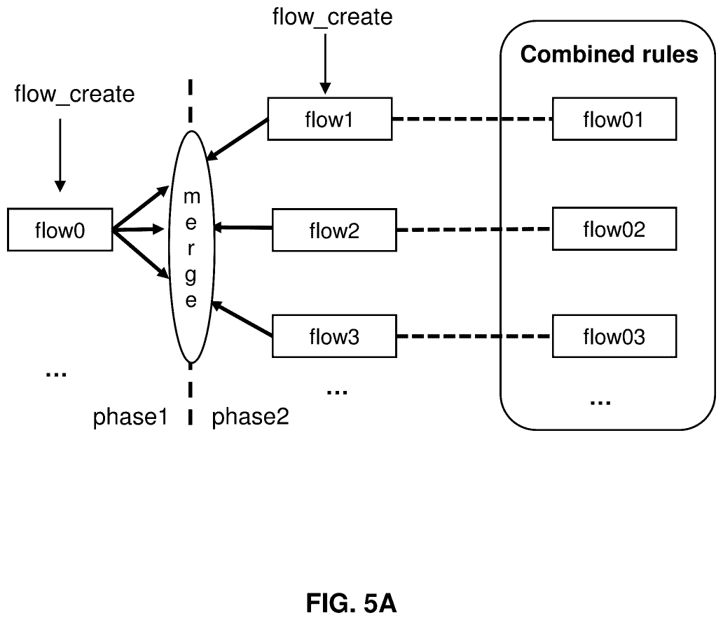

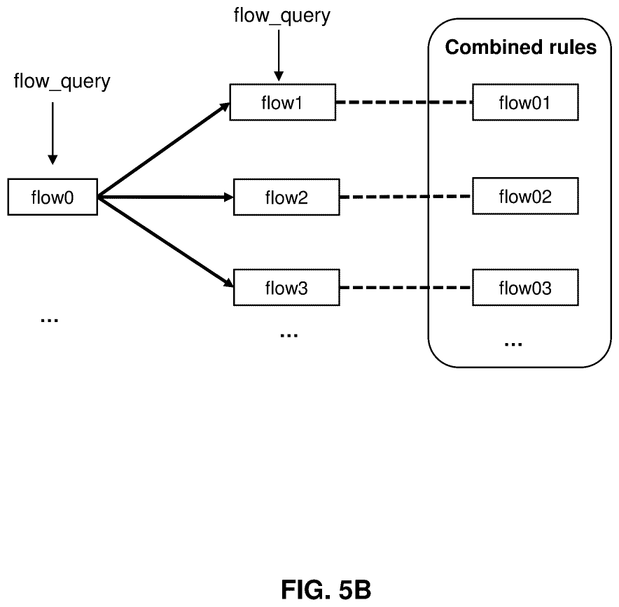

FIG. 5A depicts a process of merging rules that can be performed by a driver or other software or hardware based on flow creation API calls issued by one or more processes or an operating system (OS), orchestrator, or hypervisor. In phase 1, the driver, as a mediation layer, can classify calls to create a flow rule into a pre-decapsulation group. For example, calls to create a flow rule can include DPDK flow_create( ) API. In phase 2, the driver can perform post-decapsulation grouping based on flow creation API calls. For flow creation API calls, the driver could generate combined flow rules based on a match of flow rule of phase 1 against flow rules of phase 2 and symmetrically match a flow rule of phase 2 that match against stored flows of phase 1. The combined flow rules resulting from merging flow rules could be downloaded into the packet processing pipeline to perform on tunneled packets. For example, combined rules based on multiple flow rules for a single flow (e.g., flow0, flow1, flow2, flow3) can be generated by a network interface device driver, shown as flow01, flow02, flow03, and so forth.

FIG. 5B depicts a process of applying merged rules. A packet processing pipeline can query one or more lookup tables stored in memory for flow rules for various flows such as flow0, flow1, flow2, flow3, and so forth. Based on a one or more header field values of a packet generated by a parser, the one or more lookup tables can provide a combined flow rule (flow01, flow02, flow03) for performance by the packet processing pipeline.

VXLAN can be used to encapsulate Ethernet frames within User Datagram Protocol (UDP) datagrams. VXLAN can encapsulate a media access control (MAC) frame in a UDP datagram transported via an Internet Protocol (IP) network thereby creating an overlay network or tunnel. VXLAN endpoints (e.g., VXLAN tunnel endpoints (VTEPs)) can send (e.g., encapsulate) and terminate (e.g., decapsulate) VXLAN tunnels and may be either virtual or physical switch ports. An example implementation of VXLAN is described by Internet Engineering Task Force (IETF) in Request for Comments (RFC) 7348 (2014).

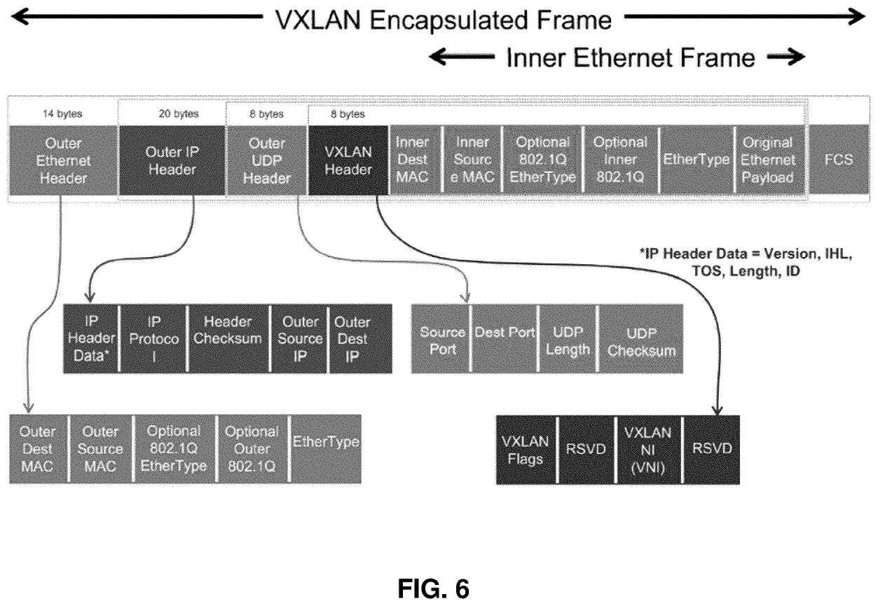

FIG. 6 depicts an example of a VXLAN encapsulated packet. A VXLAN packet can include an IP header, outer UDP header, VXLAN header, Ethernet header, and frame (e.g., MAC frame). A VXLAN header can include a virtual network identifier (VNI). A VNI can identify a particular virtual network. A tunneled packet can include one or more outer headers (e.g., UDP header (e.g., source port, destination port, length, checksum), IP header (e.g., source IP address, destination IP address, header checksum), and/or Ethernet header (e.g., source MAC address, destination MAC address, EtherType)) and frame (e.g., Ethernet frame).

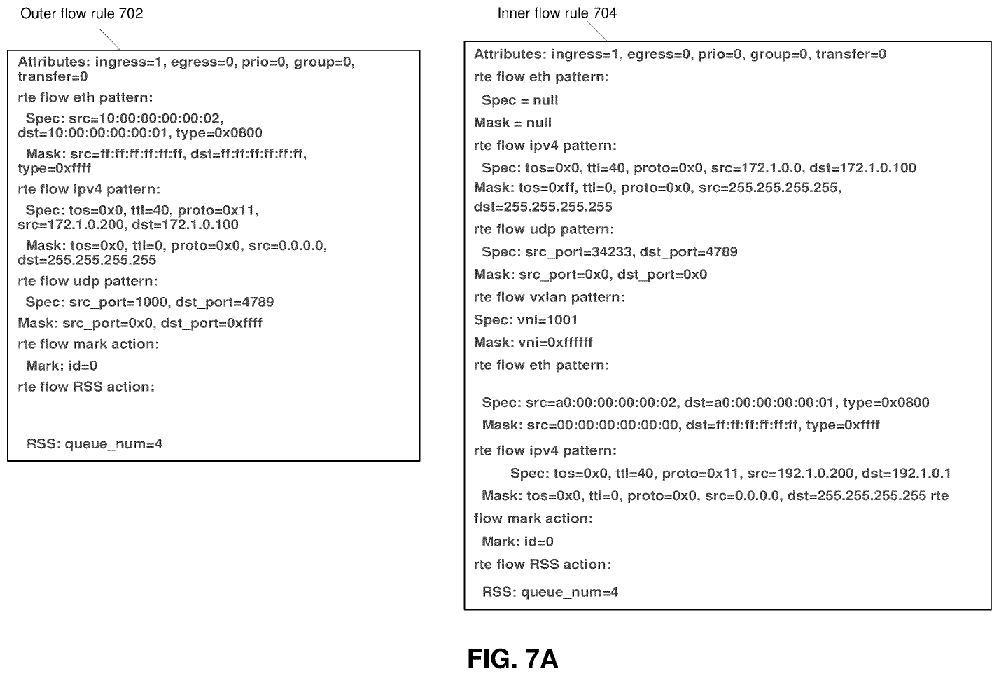

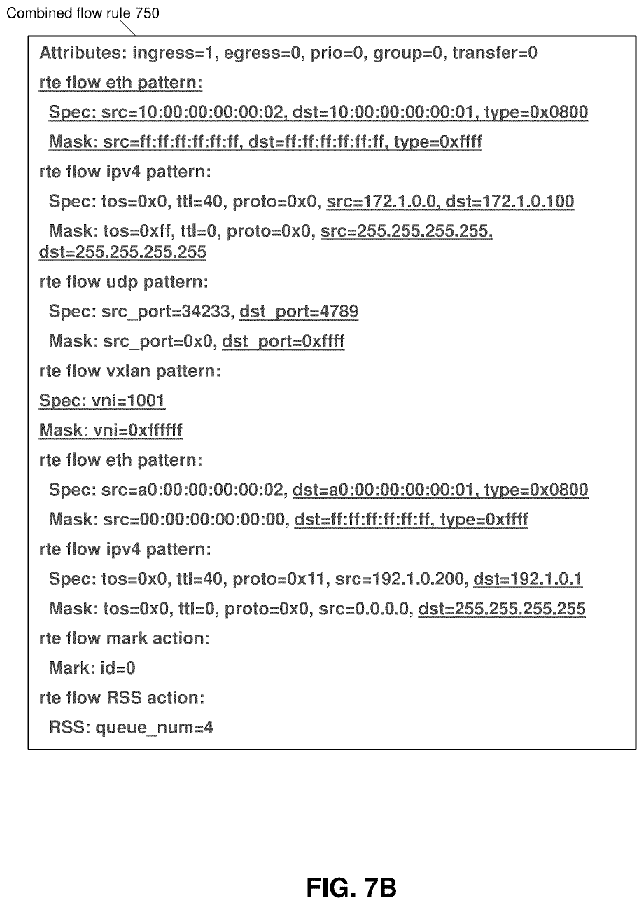

FIG. 7A depicts an example of multiple flow rules. For example, Rte_flow semantics can apply to an outer flow and an inner flow. Flow rule 702 can apply to an inner flow of a tunneled packet based on one or more outer header values of a tunneled packet. One or more outer header values can be values in one or more of: UDP header (e.g., source port, destination port, length, checksum), IP header (e.g., source IP address, destination IP address, header checksum), and/or Ethernet header (e.g., source MAC address, destination MAC address, EtherType)). Flow rule 704 can apply to an inner flow of a tunneled packet based on one or more inner header values of the tunneled packet. One or more inner header values can be values in the VXLAN header and/or Ethernet frame header or other frame or packet (e.g., inner destination MAC address, inner source MAC address, EtherType, or others).

In some examples, a driver can perform rule combination of rules 702 and 704. FIG. 7B depicts an example of a flattened flow rule 750 from flow rules 702 and 704. Underlined flow rules can represent rules that are merged from rules 702 and 704. Flattened flow rule 750 can combine rules for values in one or more outer header values and rules for values in one or more inner header values.

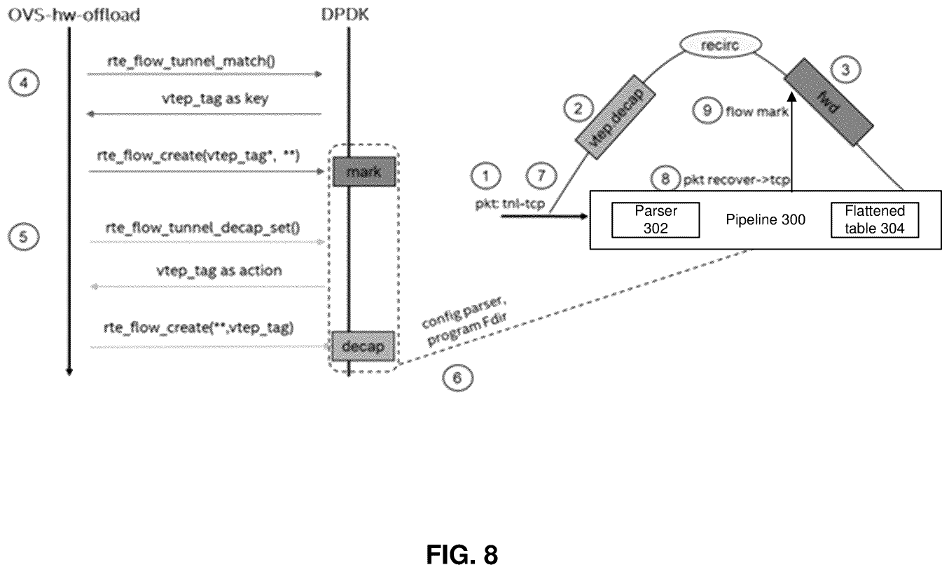

FIG. 8 depicts an example flow of tunnel offload API mediation. Various examples can apply to acceleration at least of OVS-based operations. A processor-executed driver can perform mediation and combine match-action rules for outer header of a tunnel packet and inner header forwarding rules for the tunnel packet into one entry. At (1), when a tunnel packet arrives, a processor-executed software data path (e.g., processor-executed OVS-based virtual switch) could process the outer header of the tunnel packet and at (2) perform decapsulation of the tunnel packet and recirculate the decapsulated packet to the packet processing pipeline in a network interface device. At (3), the packet processing pipeline can process the inner header of the tunnel packet to find an associated forwarding flow. The processor-executed software data path could utilize offload APIs to offload flow rules for performance by a packet processing pipeline. For example, at (4), rte_flow_tunnel_match( ) API is called to get a vendor specific tag for indicating a TEP port inside the packet processing pipeline. The tag can be used by rte_flow_create( ) API to offload the post-decapsulation flow rule. At (5), rte_flow_tunnel_decap_set( ) API is called to get a vendor specific tag for indicating decapsulation action and this tag can be used by rte_flow_create( ) API to offload the decapsulation flow rule for performance by the packet processing pipeline. The sequence of function call for the two-stage offloading may vary, depending on implementation.

At (6), a processor-executed driver could merge stage 1's flow rules and stage 2's flow rules and associate the merged rules with a private TEP tag. Processor-executed driver can configure a packet processing pipeline parser to parse one or more header fields for a specific tunnel protocol, e.g., VXLAN. After the parser is configured, the processor-executed driver can cause the merged flow rule to be downloaded into the packet processing pipeline for performance on packets. At (7), a subsequent packet from the same session and flow for which a merged rule was downloaded into the packet processing pipeline could be received and performance of the merged rule in the packet processing pipeline (e.g., Intel® Flow Director or other circuitry) could cause tagging of the packet with a flow mark. At (8), the driver could use the DPDK rte_flow_get_restore_info( ) API to remove or copy the outer header of the packet. At (9), flow mark could be used to bypass packet parsing and directly find and apply the forwarding rule for the packet from flattened table 304.

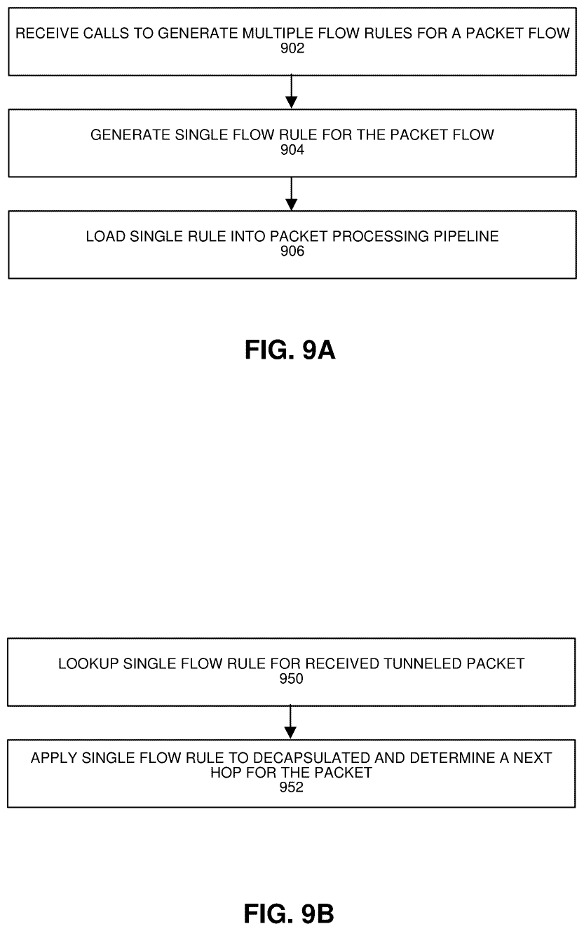

FIG. 9A depicts an example process. The process can be performed by a processor-executed driver, in some examples. At 902, multiple calls to create multiple flow rules can be received. For example, the multiple flow rules can cause decapsulation of a packet of a flow, determination of a forwarding rule for the decapsulated packet, and potentially, encapsulation of the packet based on the determined forwarding rule. At 904, based on common fields in the multiple flow rules, a single flow rule can be generated. At 906, the single flow rule can be downloaded into a table accessible to a packet processing for performance for the flow.

FIG. 9B depicts an example process. The process can be performed by a network interface device. At 950, based on receipt of a tunneled packet associated with a flow, a single flow rule in a flow table can be accessed. At 952, based on the single flow rule, the packet can be decapsulated and a forwarding rule determined for the packet.

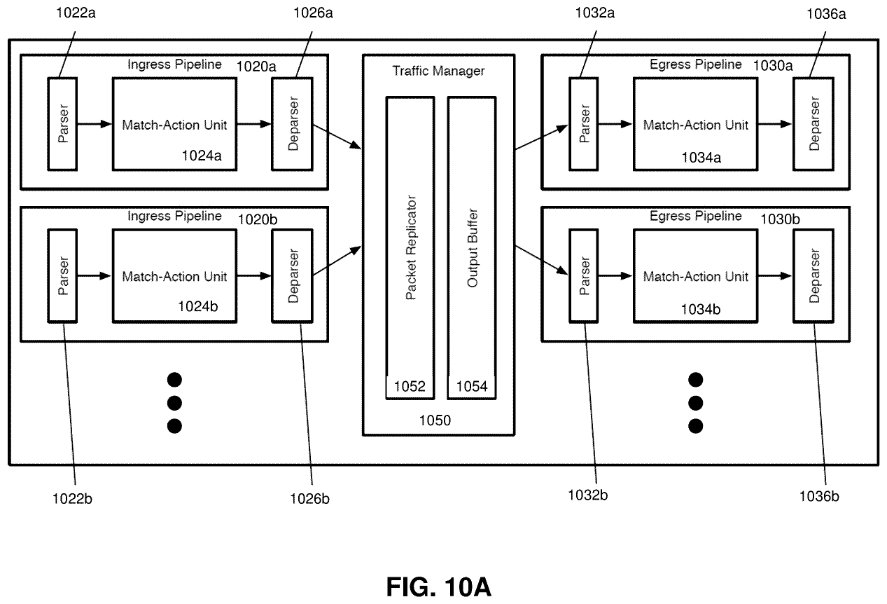

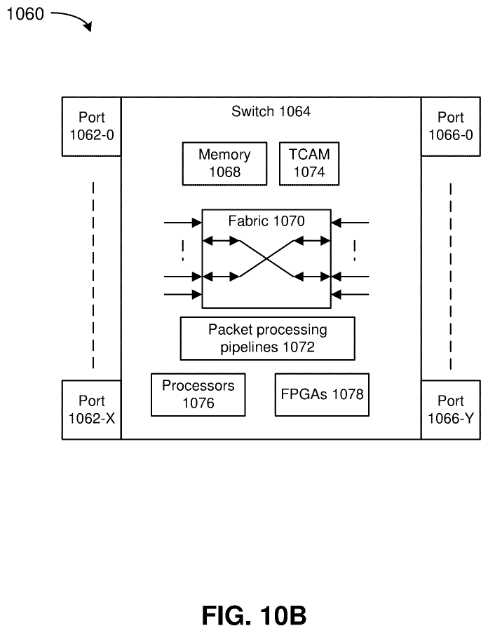

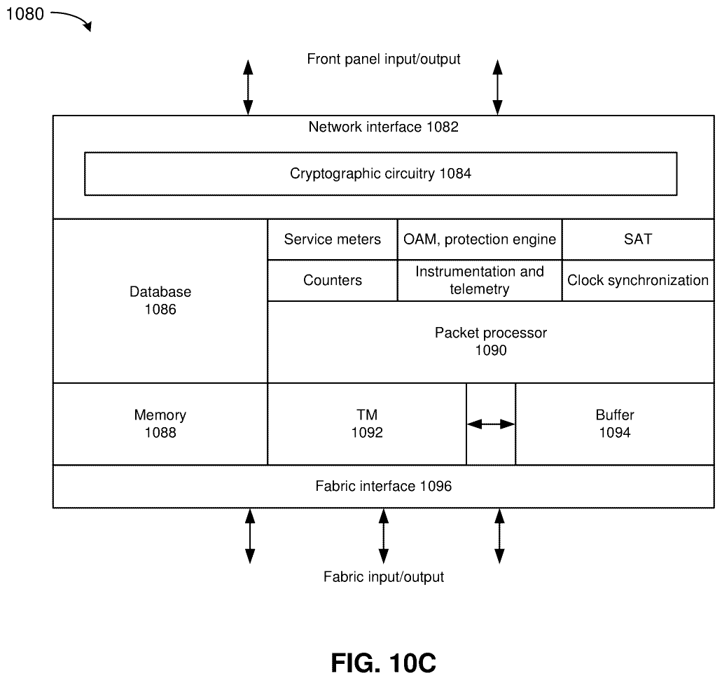

FIG. 10A depicts an example network forwarding system that can be used as a network interface device or router. Forwarding system can apply a single rule to perform decapsulation (e.g., header parsing) and forwarding of a tunneled packet, as described herein. For example, FIG. 10A illustrates several ingress pipelines 1020, a traffic management unit (referred to as a traffic manager) 1050, and several egress pipelines 1030. Though shown as separate structures, in some examples the ingress pipelines 1020 and the egress pipelines 1030 can use the same circuitry resources.

Operation of pipelines can be programmed using Programming Protocol-independent Packet Processors (P4), C, Python, Broadcom NPL, or x86 compatible executable binaries or other executable binaries. In some examples, the pipeline circuitry is configured to process ingress and/or egress pipeline packets synchronously, as well as non-packet data. That is, a particular stage of the pipeline may process any combination of an ingress packet, an egress packet, and non-packet data in the same clock cycle. However, in other examples, the ingress and egress pipelines are separate circuitry. In some of these other examples, the ingress pipelines also process the non-packet data.

In some examples, in response to receiving a packet, the packet is directed to one of the ingress pipelines 1020 where an ingress pipeline may correspond to one or more ports of a hardware forwarding element. After passing through the selected ingress pipeline 1020, the packet is sent to the traffic manager 1050, where the packet is enqueued and placed in the output buffer 1054. In some examples, the ingress pipeline 1020 that processes the packet specifies into which queue the packet is to be placed by the traffic manager 1050 (e.g., based on the destination of the packet or a flow identifier of the packet). The traffic manager 1050 then dispatches the packet to the appropriate egress pipeline 1030 where an egress pipeline may correspond to one or more ports of the forwarding element. In some examples, there is no necessary correlation between which of the ingress pipelines 1020 processes a packet and to which of the egress pipelines 1030 the traffic manager 1050 dispatches the packet. That is, a packet might be initially processed by ingress pipeline 1020b after receipt through a first port, and then subsequently by egress pipeline 1030a to be sent out a second port, etc.

A least one ingress pipeline 1020 includes a parser 1022, a chain of multiple match-action units or circuitry (MAUs) 1024, and a deparser 1026. Similarly, egress pipeline 1030 can include a parser 1032, a chain of MAUs 1034, and a deparser 1036. The parser 1022 or 1032, in some examples, receives a packet as a formatted collection of bits in a particular order, and parses the packet into its constituent header fields. In some examples, the parser starts from the beginning of the packet and assigns header fields to fields (e.g., data containers) for processing. In some examples, the parser 1022 or 1032 separates out the packet headers (up to a designated point) from the payload of the packet, and sends the payload (or the entire packet, including the headers and payload) directly to the deparser without passing through the MAU processing. Egress parser 1032 can use additional metadata provided by the ingress pipeline to simplify its processing.

MAUs 1024 or 1034 can perform processing on the packet data. In some examples, the MAUs includes a sequence of stages, with each stage including one or more match tables and an action engine. A match table can include a set of match entries against which the packet header fields are matched (e.g., using hash tables), with the match entries referencing action entries. When the packet matches a particular match entry, that particular match entry references a particular action entry which specifies a set of actions to perform on the packet (e.g., sending the packet to a particular port, modifying one or more packet header field values, dropping the packet, mirroring the packet to a mirror buffer, etc.). The action engine of the stage can perform the actions on the packet, which is then sent to the next stage of the MAU. For example, parser 1022 and MAU(s) 1024 can perform decapsulation and forwarding of a tunneled packet, as described herein.

Deparser 1026 or 1036 can reconstruct the packet using the PHV as modified by the MAU 1024 or 1034 and the payload received directly from the parser 1022 or 1032. The deparser can construct a packet that can be sent out over the physical network, or to the traffic manager 1050. In some examples, the deparser can construct this packet based on data received along with the PHV that specifies the protocols to include in the packet header, as well as its own stored list of data container locations for each possible protocol's header fields.

Traffic manager (TM) 1050 can include a packet replicator 1052 and output buffer 1054. In some examples, the traffic manager 1050 may include other components, such as a feedback generator for sending signals regarding output port failures, a series of queues and schedulers for these queues, queue state analysis components, as well as additional components. Packet replicator 1052 of some examples performs replication for broadcast/multicast packets, generating multiple packets to be added to the output buffer (e.g., to be distributed to different egress pipelines).

Output buffer 1054 can be part of a queuing and buffering system of the traffic manager in some examples. The traffic manager 1050 can provide a shared buffer that accommodates any queuing delays in the egress pipelines. In some examples, this shared output buffer 1054 can store packet data, while references (e.g., pointers) to that packet data are kept in different queues for each egress pipeline 1030. The egress pipelines can request their respective data from the common data buffer using a queuing policy that is control-plane configurable. When a packet data reference reaches the head of its queue and is scheduled for dequeuing, the corresponding packet data can be read out of the output buffer 1054 and into the corresponding egress pipeline 1030.

FIG. 10B depicts an example switch. Various examples can be used in or with the switch to perform decapsulation and forwarding of a tunneled packet, as described herein. Switch 1060 can route packets or frames of any format or in accordance with any specification from any port 1062-0 to 1062-X to any of ports 1066-0 to 1066-Y (or vice versa). Any of ports 1062-0 to 1062-X can be connected to a network of one or more interconnected devices. Similarly, any of ports 1066-0 to 1066-Y can be connected to a network of one or more interconnected devices.

In some examples, switch fabric 1070 can provide routing of packets from one or more ingress ports for processing prior to egress from switch 1064. Switch fabric 1070 can be implemented as one or more multi-hop topologies, where example topologies include torus, butterflies, buffered multi-stage, etc., or shared memory switch fabric (SMSF), among other implementations. SMSF can be any switch fabric connected to ingress ports and egress ports in the switch, where ingress subsystems write (store) packet segments into the fabric's memory, while the egress subsystems read (fetch) packet segments from the fabric's memory.

Memory 1068 can be configured to store packets received at ports prior to egress from one or more ports. Packet processing pipelines 1072 can include ingress and egress packet processing circuitry to respectively process ingressed packets and packets to be egressed. Packet processing pipelines 1072 can determine which port to transfer packets or frames to using a table that maps packet characteristics with an associated output port. Packet processing pipelines 1072 can be configured to perform match-action on received packets to identify packet processing rules and next hops using information stored in a ternary content-addressable memory (TCAM) tables or exact match tables in some examples. For example, match-action tables or circuitry can be used whereby a hash of a portion of a packet is used as an index to find an entry (e.g., forwarding decision based on a packet header content). Packet processing pipelines 1072 can implement access control list (ACL) or packet drops due to queue overflow. Packet processing pipelines 1072 can be configured to perform decapsulation and forwarding of a tunneled packet, as described herein. Configuration of operation of packet processing pipelines 1072, including its data plane, can be programmed using P4, C, Python, Broadcom Network Programming Language (NPL), or x86 compatible executable binaries or other executable binaries. Processors 1076 and FPGAs 1078 can be utilized for packet processing or modification.

FIG. 10C depicts an example switch. Various examples can be used in or with the switch to perform decapsulation and forwarding of a tunneled packet, as described herein. Switch 1080 can include a network interface 1082 that can provide an Ethernet consistent interface. Network interface 1082 can support 25 GbE, 50 GbE, 100 GbE, 200 GbE, 400 GbE Ethernet port interfaces. Cryptographic circuitry 1084 can perform at least Media Access Control security (MACsec) or Internet Protocol Security (IPSec) decryption for received packets or encryption for packets to be transmitted.

Various circuitry can perform one or more of: service metering, packet counting, operations, administration, and management (OAM), protection engine, instrumentation and telemetry, and clock synchronization (e.g., based on IEEE 1588).

Database 1086 can store a device's profile to configure operations of switch 1080. Memory 1088 can include High Bandwidth Memory (HBM) for packet buffering. Packet processor 1090 can perform one or more of: decision of next hop in connection with packet forwarding, packet counting, access-list operations, bridging, routing, Multiprotocol Label Switching (MPLS), virtual private LAN service (VPLS), L2VPNs, L3VPNs, OAM, Data Center Tunneling Encapsulations (e.g., VXLAN and NV-GRE), or others. Packet processor 1090 can include one or more FPGAs. Buffer 1094 can store one or more packets. Traffic manager (TM) 1092 can provide per-subscriber bandwidth guarantees in accordance with service level agreements (SLAs) as well as performing hierarchical quality of service (QOS). Fabric interface 1096 can include a serializer/de-serializer (SerDes) and provide an interface to a switch fabric.

Operations of components of switches of examples of devices of FIGS. 10A, 10B, and/or 10C can be combined and components of the switches of examples of FIGS. 10A, 10B, and/or 10C can be included in other examples of switches of examples of FIGS. 10A, 10B, and/or 10C. For example, components of examples of switches of FIGS. 10A, 10B, and/or 10C can be implemented in a switch system on chip (SoC) that includes at least one interface to other circuitry in a switch system. A switch SoC can be coupled to other devices in a switch system such as ingress or egress ports, memory devices, or host interface circuitry.

FIG. 11 depicts a system. In some examples, circuitry of system 1100 can configure network interface device 1150 to perform decapsulation and forwarding of a tunneled packet, as described herein. System 1100 includes processor 1110, which provides processing, operation management, and execution of instructions for system 1100. Processor 1110 can include any type of microprocessor, central processing unit (CPU), graphics processing unit (GPU), XPU, processing core, or other processing hardware to provide processing for system 1100, or a combination of processors. An XPU can include one or more of: a CPU, a graphics processing unit (GPU), general purpose GPU (GPGPU), and/or other processing units (e.g., accelerators or programmable or fixed function FPGAs). Processor 1110 controls the overall operation of system 1100, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1100 includes interface 1112 coupled to processor 1110, which can represent a higher speed interface or a high throughput interface for system components that needs higher bandwidth connections, such as memory subsystem 1120 or graphics interface components 1140, or accelerators 1142. Interface 1112 represents an interface circuit, which can be a standalone component or integrated onto a processor die. Where present, graphics interface 1140 interfaces to graphics components for providing a visual display to a user of system 1100. In one example, graphics interface 1140 generates a display based on data stored in memory 1130 or based on operations executed by processor 1110 or both. In one example, graphics interface 1140 generates a display based on data stored in memory 1130 or based on operations executed by processor 1110 or both.

Accelerators 1142 can be a programmable or fixed function offload engine that can be accessed or used by a processor 1110. For example, an accelerator among accelerators 1142 can provide data compression (DC) capability, cryptography services such as public key encryption (PKE), cipher, hash/authentication capabilities, decryption, or other capabilities or services. In some cases, accelerators 1142 can be integrated into a CPU socket (e.g., a connector to a motherboard or circuit board that includes a CPU and provides an electrical interface with the CPU). For example, accelerators 1142 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1142 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 1120 represents the main memory of system 1100 and provides storage for code to be executed by processor 1110, or data values to be used in executing a routine. Memory subsystem 1120 can include one or more memory devices 1130 such as read-only memory (ROM), flash memory, one or more varieties of random access memory (RAM) such as DRAM, or other memory devices, or a combination of such devices. Memory 1130 stores and hosts, among other things, operating system (OS) 1132 to provide a software platform for execution of instructions in system 1100. Additionally, applications 1134 can execute on the software platform of OS 1132 from memory 1130. Applications 1134 represent programs that have their own operational logic to perform execution of one or more functions. Processes 1136 represent agents or routines that provide auxiliary functions to OS 1132 or one or more applications 1134 or a combination. OS 1132, applications 1134, and processes 1136 provide software logic to provide functions for system 1100. In one example, memory subsystem 1120 includes memory controller 1122, which is a memory controller to generate and issue commands to memory 1130. It will be understood that memory controller 1122 could be a physical part of processor 1110 or a physical part of interface 1112. For example, memory controller 1122 can be an integrated memory controller, integrated onto a circuit with processor 1110.

Applications 1134 and/or processes 1136 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 1132 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 1132, a system administrator, and/or orchestrator can configure network interface 1150 to perform decapsulation and forwarding of a tunneled packet, as described herein.

While not specifically illustrated, it will be understood that system 1100 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1100 includes interface 1114, which can be coupled to interface 1112. In one example, interface 1114 represents an interface circuit, which can include standalone components and integrated circuitry. In one example, multiple user interface components or peripheral components, or both, couple to interface 1114. Network interface 1150 provides system 1100 the ability to communicate with remote devices (e.g., servers or other computing devices) over one or more networks. Network interface 1150 can include an Ethernet adapter, wireless interconnection components, cellular network interconnection components, USB (universal serial bus), or other wired or wireless standards-based or proprietary interfaces. Network interface 1150 can transmit data to a device that is in the same data center or rack or a remote device, which can include sending data stored in memory. Network interface 1150 can receive data from a remote device, which can include storing received data into memory. In some examples, packet processing device or network interface device 1150 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described with respect to FIGS. 10A, 10B, and/or 10C.

In one example, system 1100 includes one or more input/output (I/O) interface(s) 1160. I/O interface 1160 can include one or more interface components through which a user interacts with system 1100. Peripheral interface 1170 can include any hardware interface not specifically mentioned above. Peripherals refer generally to devices that connect dependently to system 1100.

In one example, system 1100 includes storage subsystem 1180 to store data in a nonvolatile manner. In one example, in certain system implementations, at least certain components of storage 1180 can overlap with components of memory subsystem 1120. Storage subsystem 1180 includes storage device(s) 1184, which can be or include any conventional medium for storing large amounts of data in a nonvolatile manner, such as one or more magnetic, solid state, or optical based disks, or a combination. Storage 1184 holds code or instructions and data 1186 in a persistent state (e.g., the value is retained despite interruption of power to system 1100). Storage 1184 can be generically considered to be a “memory,” although memory 1130 is typically the executing or operating memory to provide instructions to processor 1110. Whereas storage 1184 is nonvolatile, memory 1130 can include volatile memory (e.g., the value or state of the data is indeterminate if power is interrupted to system 1100). In one example, storage subsystem 1180 includes controller 1182 to interface with storage 1184. In one example controller 1182 is a physical part of interface 1114 or processor 1110 or can include circuits or logic in both processor 1110 and interface 1114.

A volatile memory can include memory having a state (and therefore the data stored in it) is indeterminate if power is interrupted to the device. A non-volatile memory (NVM) device can include a memory whose state is determinate even if power is interrupted to the device.

In some examples, system 1100 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 1100 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

Example 1 includes one or more examples, and includes at least one non-transitory computer-readable medium, comprising instructions stored thereon, that when executed by circuitry, causes the circuitry to: identify two or more match-action rules to program a packet processing circuitry to process a tunnel packet, wherein the tunnel packet comprises an encapsulation header and an encapsulated header and wherein at least one of the two or more match-action rules comprises a rule for a value of the encapsulation header of the tunnel packet and another at least one of the two or more match-action rules comprises a rule for a value of the encapsulated header in the tunnel packet and based on the identified two or more match-action rules, determine a single match-action rule based on the two or more match-action rules, wherein the single match-action rule comprises the value of the encapsulation header of the tunnel packet and the value of the encapsulated header and wherein the packet processing pipeline is to perform the single match-action rule for associated packets.

Example 2 includes one or more examples, wherein the determine the single match-action rule based on the two or more match-action rules comprises combine the two or more match-action rules.

Example 3 includes one or more examples, wherein the packet processing circuitry comprises an ingress circuitry and an egress pipeline and wherein the perform the single match-action rule for associated packets does not cause loopback of the associated packets through the packet processing circuitry.

Example 4 includes one or more examples, wherein to perform the single match-action rule for associated packets, the packet processing circuitry is to identify a tunnel and determine a receiver network device.

Example 5 includes one or more examples, wherein the tunnel packet is based on one or more of: Multiprotocol Label Switching (MPLS), Label Distribution Protocol (LDP), Segment Routing over IPv6 dataplane (SRv6), Virtual Extensible LAN (VXLAN) tunnelled traffic, or GENEVE tunnelled traffic.

Example 6 includes one or more examples, wherein the instructions comprise a network interface device driver or compiler.

Example 7 includes one or more examples, wherein the single match-action rule comprises a rule based on one or more of: a virtual network interface (VNI) identifier, destination port number, destination internet protocol (IP) address, or EtherType value indicative of IPV4 or IPv6 datagram.

Example 8 includes one or more examples, and includes an apparatus comprising: a network interface device comprising: a direct memory access (DMA) circuitry; a host interface; a network interface; and circuitry to: apply, for a tunnel packet, a single match-action rule that comprises a value of an encapsulation header of the tunnel packet and a value of an encapsulated header, wherein the single match-action rule is based on two or more match-action rules.

Example 9 includes one or more examples, wherein the single match-action rule is based on a combination of two or more match-action rules.

Example 10 includes one or more examples, wherein the tunnel packet is based on one or more of: Multiprotocol Label Switching (MPLS), Label Distribution Protocol (LDP), Segment Routing over IPv6 dataplane (SRv6), Virtual Extensible LAN (VXLAN) tunnelled traffic, or GENEVE tunnelled traffic.

Example 11 includes one or more examples, wherein the circuitry comprises a packet processing pipeline that comprises an ingress pipeline and an egress pipeline.

Example 12 includes one or more examples, wherein the circuitry is to determine a forwarding rule for the tunnel packet based on the single match-action rule without packet recirculation through a packet processing pipeline.

Example 13 includes one or more examples, wherein the apply, for the tunnel packet, the single match-action rule comprises identify a tunnel and determine a receiver network device.

Example 14 includes one or more examples, wherein the single match-action rule comprises a rule based on one or more of: a virtual network interface (VNI) identifier, destination port number, destination internet protocol (IP) address, or EtherType value indicative of IPV4 or IPv6 datagram.

Example 15 includes one or more examples, and includes a method that includes: in a network interface device, wherein the network interface device comprises a packet processing pipeline that comprises an ingress pipeline and an egress pipeline: applying, for a tunnel packet, a single match-action rule that comprises a value of an encapsulation header of the tunnel packet and a value of an encapsulated header, wherein the single match-action rule is based on two or more match-action rules.

Example 16 includes one or more examples, wherein the single match-action rule is based on a combination of two or more match-action rules.

Example 17 includes one or more examples, wherein the tunnel packet is based on one or more of: Multiprotocol Label Switching (MPLS), Label Distribution Protocol (LDP), Segment Routing over IPv6 dataplane (SRv6), Virtual Extensible LAN (VXLAN) tunnelled traffic, or GENEVE tunnelled traffic.

Example 18 includes one or more examples, wherein the applying, for a tunnel packet, a single match-action rule comprises determining a forwarding rule for the tunnel packet without packet recirculation through a packet processing pipeline.

Example 19 includes one or more examples, wherein the applying, for a tunnel packet, a single match-action rule comprises identifying a tunnel and determining a receiver network device.

Example 20 includes one or more examples, wherein the single match-action rule comprises a rule based on one or more of: a virtual network interface (VNI) identifier, destination port number, destination internet protocol (IP) address, or EtherType value indicative of IPV4 or IPv6 datagram.

1. At least one non-transitory computer-readable medium, comprising instructions stored thereon, that when executed by circuitry, causes the circuitry to:
identify two or more match-action rules to program a packet processing circuitry to process a tunnel packet, wherein the tunnel packet comprises an encapsulation header and an encapsulated header and wherein at least one of the two or more match-action rules comprises a rule for a value of the encapsulation header of the tunnel packet and another at least one of the two or more match-action rules comprises a rule for a value of the encapsulated header in the tunnel packet and
based on the identified two or more match-action rules, determine a single match-action rule based on the two or more match-action rules, wherein the single match-action rule comprises the value of the encapsulation header of the tunnel packet and the value of the encapsulated header and wherein the packet processing pipeline is to perform the single match-action rule for associated packets.

2. The non-transitory computer-readable medium of claim 1, wherein the determine the single match-action rule based on the two or more match-action rules comprises combine the two or more match-action rules.

3. The non-transitory computer-readable medium of claim 1, wherein the packet processing circuitry comprises an ingress circuitry and an egress pipeline and wherein the perform the single match-action rule for associated packets does not cause loopback of the associated packets through the packet processing circuitry.

4. The non-transitory computer-readable medium of claim 1, wherein to perform the single match-action rule for associated packets, the packet processing circuitry is to identify a tunnel and determine a receiver network device.

5. The non-transitory computer-readable medium of claim 1, wherein the tunnel packet is based on one or more of: Multiprotocol Label Switching (MPLS), Label Distribution Protocol (LDP), Segment Routing over IPv6 dataplane (SRv6), Virtual Extensible LAN (VXLAN) tunnelled traffic, or GENEVE tunnelled traffic.

6. The non-transitory computer-readable medium of claim 1, wherein the instructions comprise a network interface device driver or compiler.

7. The non-transitory computer-readable medium of claim 1, wherein the single match-action rule comprises a rule based on one or more of: a virtual network interface (VNI) identifier, destination port number, destination internet protocol (IP) address, or EtherType value indicative of IPv4 or IPv6 datagram.

8. An apparatus comprising:
a network interface device comprising:
a direct memory access (DMA) circuitry;
a host interface;
a network interface; and
circuitry to:
apply, for a tunnel packet, a single match-action rule that comprises a value of an encapsulation header of the tunnel packet and a value of an encapsulated header, wherein the single match-action rule is based on two or more match-action rules.

9. The apparatus of claim 8, wherein the single match-action rule is based on a combination of two or more match-action rules.

10. The apparatus of claim 8, wherein the tunnel packet is based on one or more of: Multiprotocol Label Switching (MPLS), Label Distribution Protocol (LDP), Segment Routing over IPv6 dataplane (SRv6), Virtual Extensible LAN (VXLAN) tunnelled traffic, or GENEVE tunnelled traffic.

11. The apparatus of claim 8, wherein the circuitry comprises a packet processing pipeline that comprises an ingress pipeline and an egress pipeline.

12. The apparatus of claim 8, wherein the circuitry is to determine a forwarding rule for the tunnel packet based on the single match-action rule without packet recirculation through a packet processing pipeline.

13. The apparatus of claim 8, wherein the apply, for the tunnel packet, the single match-action rule comprises identify a tunnel and determine a receiver network device.

14. The apparatus of claim 8, wherein the single match-action rule comprises a rule based on one or more of: a virtual network interface (VNI) identifier, destination port number, destination internet protocol (IP) address, or EtherType value indicative of IPV4 or IPv6 datagram.

15. A method comprising:
in a network interface device, wherein the network interface device comprises a packet processing pipeline that comprises an ingress pipeline and an egress pipeline:
applying, for a tunnel packet, a single match-action rule that comprises a value of an encapsulation header of the tunnel packet and a value of an encapsulated header, wherein the single match-action rule is based on two or more match-action rules.

16. The method of claim 15, wherein the single match-action rule is based on a combination of two or more match-action rules.

17. The method of claim 15, wherein the tunnel packet is based on one or more of: Multiprotocol Label Switching (MPLS), Label Distribution Protocol (LDP), Segment Routing over IPv6 dataplane (SRv6), Virtual Extensible LAN (VXLAN) tunnelled traffic, or GENEVE tunnelled traffic.

18. The method of claim 15, wherein the applying, for a tunnel packet, a single match-action rule comprises determining a forwarding rule for the tunnel packet without packet recirculation through a packet processing pipeline.

19. The method of claim 15, wherein the applying, for a tunnel packet, a single match-action rule comprises identifying a tunnel and determining a receiver network device.

20. The method of claim 15, wherein the single match-action rule comprises a rule based on one or more of: a virtual network interface (VNI) identifier, destination port number, destination internet protocol (IP) address, or EtherType value indicative of IPv4 or IPv6 datagram.
